(19) United States
(12) Patent Application Publication
(10) Pub. No.: US 2021/0369426 A1
(43) Pub. Date: Dec. 2, 2021

(54) SYSTEMS AND METHODS FOR CUSTOMIZED AND PERSONALIZED ORAL IRRIGATOR

(71) Applicant: Watercare Technologies Limited, Quarry Bay (HK)

(72) Inventors: Huafeng WEN, Redwood Shores, CA (US); James Zhao-Hui ZHANG, Palo Alto, CA (US)

(73) Assignee: Watercare Technologies Limited, Quarry Bay (HK)

(21) Appl. No.: 17/398,893

(22) Filed: Aug. 10, 2021

Related U.S. Application Data
(63) Continuation of application No. PCT/US2020/030480, filed on Apr. 29, 2020.
(60) Provisional application No. 62/841,947, filed on May 2, 2019.

(51) Int. Cl. A61C 17/02; A61C 9/00

(52) U.S. Cl. CPC A61C 17/0211; A61C 9/0053

(57) ABSTRACT

A customized oral irrigator which is adapted to the user's dentition, has multiple nozzles or cutout openings to point to the area to irrigate. User can anchor such device by biting with the teeth and irrigate the teeth and gum, especially between the teeth and under the gum, in one instance. Such a device is fast and effective. It will be beneficial to everyone but will especially benefit busy professionals, children, seniors, handicapped, disabled, and other users who have difficulty cleaning teeth, for example people who wear dental devices such as braces. This device is meant to combine oral care procedures such as tooth brushing and dental flossing in one instance and will yield better dental hygiene and with better compliance than conventional brushing and flossing and conventional single channel oral irrigators.

### CROSS-REFERENCE TO RELATED APPLICATIONS

This application is a continuation of International Patent Application No. PCT/US2020/030480 filed on Apr. 29, 2020, which claims the benefit of U.S. Provisional Application No. 62/841,947 filed May 2, 2019, the contents of which are hereby incorporated by reference in their entirety.

### FIELD OF THE INVENTION

This invention relates, in general, to devices for a customized and personalized oral device, which a user bites on and uses water jets to irrigate teeth and gums quickly, efficiently and effectively.

### BACKGROUND OF THE INVENTION

WaterPik® (Water Pik, Inc., Fort Collins, Colo.) and other conventional oral irrigators typically include a base unit having a reservoir, and a separate hand-held portion having a tip or wand that is connected to the reservoir with a tube. In use, a user directs fluid streams or pulses by pointing the tip of the hand-held portion in the desired position towards the users gum line. The benefits of regular oral irrigation of the teeth and gums are well-known, but because conventional oral irrigators have just a tip to point to the teeth and gum area and are often handheld, they are difficult to aim at the area which needs to be irrigated and it normally takes a long time to traverse the entire mouth.

What is needed is a customized and personalized oral irrigator which is adapted to the user's dentition, has multiple nozzles or cutout openings to point to the exact area to irrigate.

US 2019/0142559 A1, entitled “TOOTH CLEANING APPLIANCE”, to Yan SUN, describes an advance in the art that is made according to an aspect of the present disclosure directed to a convenient, efficient, economical and effective tooth cleaning appliance. In sharp contrast, appliances, structures, methods and techniques according to the present invention use mouthpiece appliance(s), water jets, brushes, and sonics/ultrasonics as shown and described to produce an effective and inexpensive cleaning appliance that may be custom made and or fit to a particular user according to her particular dental hygiene requirements. However, the reference describes a sprinkler-like system in the mouth, where water comes from a water pipe, then splits to different water channels, on each change, spray jets are installed along to spray the teeth. In addition, different toothbrush heads can be installed with spray jets. The described device is not practical to build channels which apply to the region of interests. In order to apply pressure, multi parallel channels may be needed as well, this could make the device more complicated and bulkier, and expensive. The result can be spotty and fail to provide good coverage for all the teeth. A much more sophisticated system is needed to spray wash the teeth effectively.

US 2018/0344440, entitled “ORAL CARE CLEANING SYSTEM UTILIZING ENTRAINED FLUID”, to Johnson & Johnson Consumer Inc. provides for oral care systems having an appliance with a first and second plurality of nozzles, the appliance configured to be held in the mouth of a user with the first and second plurality of nozzles in fluid communication with one or more surfaces of the user's oral cavity; a source of gas; a source of liquid; and a fluid controller for directing entrained fluid to the appliance. Also provided are methods of cleaning, or otherwise providing oral care benefits to, one or more surfaces of the oral cavity. This device uses two layers of nozzles one gas layer, then a liquid layer, to power wash the teeth; however, as teeth are sensitive to water pressure and excessive water is hard to drain from mouth, this system is impractical.

U.S. Pat. No. 10,195,006, entitled “INTRAORAL DENTAL IRRIGATION APPLIANCE” describes a dual-purpose occlusal guard and irrigation device. The appliance can protect the teeth of the user from the damage caused by bruxism and even provide the user the ability to effectively irrigate some or all difficult areas of dentition. The appliance includes at least one port configured to receive an irrigation fluid, or irrigant. This port may attach to a fluid source like a tap, water irrigation device, or other moving fluid supply. This is more like a dripping system in which sinusoidal pattern like drippers are laid on the occlusal surface of teeth and drip liquid to irrigate the teeth. The drippers can slowly wash teeth but they may take a long time to clean the teeth, and may likely not clean hard-to-reach areas.

US 2019/0000599, entitled “SYSTEMS AND METHODS FOR PERSONALIZED ORAL IRRIGATION”, describe systems and methods for providing personalized oral irrigation. One variation of a system for personalized oral irrigation comprises a fluid reservoir and a customized oral insert in fluid communication with the fluid reservoir. The oral insert comprises an arrangement of fluid openings positioned based on the individual oral or dental structures of a user's teeth to provide a customized fluid flow over the user's teeth. However, this system has fundamental limitations as the pipe structure limits the flow from one point of the arch to the other point, in which the pressure diminishes quite a lot, and in order to compensate the pressure drop, a manifold pipe structure is proposed. A manifold may have several parameters that can be tuned to control the fluid velocity at each nozzle, but such a structure needs pipes to send liquid to different sections of teeth, and adds extra thickness to the device, as it becomes bulkier and makes it harder for a user to place the upper arch part and lower arch part into the mouth. Placement of the upper part and lower part separately makes the wash longer, with more work and inconvenience for user. Although the reference described many nozzle designs aimed at different tooth structures, such a design is predefined, and laid out through the device, it cannot cover the complex tooth structure which needs more dynamic structures, shape-based tooth dentation. So it focuses on a lay out of predesigned nozzles designs in which the nozzle covers power wash portions of the teeth leaving regions which are unable to be washed properly. The layout grid has to cover regions by regions to completely wash the area in case of crowded teeth. Furthermore, there is no place to plug designed nozzles. Smaller nozzles are unable to produce the needed water pressure flow, and they are difficult to manufacture as well. The limitation is the pipe nozzle structure which lacks a flow dynamics design to produce a true dynamics outlet to liquid which is the limitation.

US 2018/0116773, entitled “CUSTOM-MADE ORAL HYGIENE DEVICE FOR DAILY TEETH CLEANING AND POLISHING” describes a custom dental irrigation device having a user dentition model; a custom-made mouthpiece made according to the user dentition model, a pump configured to pump fluid to the mouthpiece; a suction pump configured to remove fluid from the mouthpiece; a fluid tank; and a controller. The custom-made mouthpiece is configured to deliver fluid to the dental target while removing used irrigation fluid. The mouthpiece is fabricated with 3-D print techniques. The mouthpiece is designed in two pieces to cover an upper portion of a dental target and a lower portion of a dental target separately. The mouthpiece has an inner surface following the shape of the user dentition model, wherein the inner surface touches the gingiva tissue to form a sealed space once the mouthpiece is set in a user's mouth, whereby fluid is delivered to the dental target, and removed from the sealed space. This application uses close contact to the gums to have an enclosure space, so liquid can be kept in the mouth while washing. However, this design fails to work well with power wash applications, where a larger volume space is needed to retain water, and to quickly drain in order to clear the way for more liquid to power through.

US 2011/0318705, entitled “HYDRO CLEAN AUTO FLOSS” provides a molded mouth-guard type mouthpiece configured in a U shape to conform to the contours of a set of human teeth, having a trough to receive the teeth, further comprising an irrigation water flow component at the front thereof consisting of an attachable tubing apparatus, allowing users to floss all of the teeth by means of pressurized water, at once, whether at home or on the go. A series of small circular openings are positioned along the perimeter of the mouthpiece, serving as the egress for water. At the front of the mouthpiece is positioned the attachment point for the irrigation water flow component. The irrigation water flow component comprises one central inlet nozzle, and two outlet nozzles, positioned on each side of the inlet nozzle. All of these nozzles are designed to receive tubing by means of a force fit. At the opposite end of the inlet hose is a spout adapter that is configured to accommodate most sink faucets. Use of a multi-jet in a U-shaped carrier to floss teeth will just spill water all over mouth without if not customized to individual teeth.

U.S. Pat. No. 9,788,922 entitled “SYSTEMS AND METHODS FOR REMOVAL OF DENTAL BIOFILM USING IRRIGATION” describes a custom fit tray that fits over the teeth and seals against the gum of a mammal. A number of ports are embedded in the tray, each in fluid communication with a hose or line supplied with either a vacuum or an irrigant/fluid source. A small space between the tray and the teeth provides for fluid to flow around the teeth. A router may be connected to both an irrigant fluid supply reservoir and a vacuum pump to direct either fluid or vacuum to the various hoses with the routing changing over time for optimum cleaning. Air may be injected into the cleaning fluid in varying amounts, to create bubbles, water droplets, and/or boluses of the cleaning fluid to increase and focus the hydrodynamic forces of the fluid upon reaching the teeth. The described device uses biofilms which are connected to inlets and outlets. This may be a cheaper way to produce a customized watering device by deforming the biofilm to tooth shape, but the effective the wash can be poor, as every droplet is uniformly distributed.

US 2013/0260332, entitled “AN ORAL HYGIENE APPLIANCE” is provided having an upper and lower appliance member formed of an arcuate channel for placement over a wearer's upper and lower teeth and gum lines. The channels are comprised of an inner and outer layer sandwiching an internal pathway for routing a pressurized cleaning solution therethrough. The pathway is a network of tubules or a formed pathway between the channel layers, the pathway having a main conduit, branches, and outlets through the channel inner layers. The frontal portion of the appliance connects to at least one lead tube. The lead tubes further connect to an external fluid pump and reservoir of cleaning solution, which is pumped into the pathways of the upper and lower appliance and exit the outlets to spray remove plaque, tarter, and food particles. The device may be used in replacement of or in addition to traditional toothbrush cleaning routines; however, the devices uses the pipe and branch structure and irrigation which is difficult to place a power wash inside a limited spaced mouth.

US 2017/0056143, entitled “AN APPARATUS FOR CLEANING THE ORAL CAVITY” comprises a body including insertion slots into which the teeth of a user can be inserted, a plurality of injection holes and a plurality of aspiration holes formed on the inner wall of the insertion slots; a feeding tube for supplying cleaning liquid to the plurality of injection holes; a discharge tube through which the cleaning liquid is externally discharged via the plurality of aspiration holes; and a switching member for switching the direction of injection and the direction of aspiration of the cleaning liquid, wherein the body includes a first inner space which communicates with the plurality of injection holes, and a second inner space which communicates with the plurality of aspiration holes. This device is another application which allows water inlets to come in and irrigate teeth and have a switch of pump and drain functions at pipe.

US 2018/0140402, entitled “HIGH-PRESSURE-WATER TOOTHBRUSH AND U-SHAPED JET-WASHING GROOVE STRUCTURE THEREOF” provides a high-pressure-water toothbrush and a U-shaped jet-washing groove structure thereof, comprising: a handle and a U-shaped jet-washing groove provided at an end of the handle. The U-shaped jet-washing groove structure has a first sidewall and a second sidewall facing the first sidewall, and each of the first sidewall and the second sidewall has an inner wall surface provided with a plurality of nozzles. The insides and outsides of the teeth surfaces and teeth gaps can be simultaneously flush for the purpose of quick and effective to cleaning the teeth. The U-shaped jet washing groove can slide along the arch to clean section by section like a toothbrush or connect all U-shaped jet washing groove to cover the entire arch, so teeth can be power washed in one shot. However, the nozzles are not custom designed which allows for the sprays to pass anywhere like a multi-jet WaterPik® device.

CN 208864531, entitled “HIGH-PRESSURE WATER SPRAY TOOTHBRUSH AND ITS U-SHAPED GROOVE STRUCTURE” describes a high-pressure water spray toothbrush structure and its U-shaped groove structure, which comprises: Operating handle, as well as U-shaped spray wash tank disposed on one side of the operating handle, U-type spray wash tank has two mutually facing the first sidewall and the second sidewall. And in the first side wall and a second side wall of the side wall, respectively, provided with a plurality of liquid spray nozzles. However, this device again shows a U-Shape model without customization.

KR 101298491, entitled “A MOUTH CLEANSER AND A MANUFACTURING METHOD THEREOF” are provided to wash teeth by customizing a base having upper and lower teeth of a teeth receiving unit according to tooth arrangement. The manufacturing method of mouth cleanser is described as comprising the following steps: a first step which takes individual tooth impression; a second step which manufactures a plaster model by pouring gypsum into the impression; a third step which blocks out gypsum shaped teeth shape with plasticized silicone in order to form a space in which water current can be emitted; a fourth step which manufactures a base which is coincided with tooth structure and arrangement by using a heat vacuum compressive molder on top of the block out model; a fifth step which is broken away form of the base and penetrated into a plurality of water current nozzles; a sixth step which blocks out with plasticized silicone; a seventh step which locates an inner adaptor in which a hole is formed in upper middle part of the plasticized silicone; a eighth step which manufactures housing by using the heat vacuum compressive molder on top of the block out model; and a ninth step which forms a central hole which is accorded with the hole of the inner adapter and inserts an outer adapter into the central hole. The described device provides a way to manually create mouth-washing using molds, gypsum, silicones, and while it can be inexpensive to make, this device may not be effective to clean teeth.

U.S. Pat. No. 8,684,956, entitled “ORAL CARE DEVICE” describes a device for directing a liquid onto a plurality of surfaces of the oral cavity, the device including a chamber for maintaining the liquid proximate the surfaces, where the chamber is defined by front, rear and base inner walls of the device and the front and rear inner walls each include a plurality of openings, the devices further including a first manifold and a second manifold, a first port and a second port; and means for providing an effective seal of the device within the oral cavity. This is another multi jet washing device, which fails to customize to individual teeth.

In order to clean teeth effectively, the wash cannot be blind but is ideally customized to aim the water to the right directions and have the proper pressure as well. To achieve such, a customized device based on tooth surface and internal structure to make the water flow reach the target is needed to makes the product compact enough to be insert in the mouth easily and quickly to clean teeth, so as to not leave any blind spots for lack of cleaning.

### SUMMARY OF THE INVENTION

According to one broad aspect of one embodiment of the present invention, disclosed herein is a custom made mouthpiece, often 3D printed, such device has at least one connector to connect to a pump to pump either liquid or air into the device, liquid can be mixed with water, tooth cleaning agent, or teeth whitening agent.

Users can anchor such a device by biting with the teeth, active the irrigation, and irrigate the teeth and gum in one treatment. In rare cases, if the water pressure is not able to irrigate all of the areas in one treatment, switches can be installed to irrigate one arch or one quadrant at a time. Such a device is fast and effective. It will be beneficial to everyone but will especially benefit busy professionals, children, seniors, handicapped, disabled, and other users who have difficulty cleaning teeth, for example people who wear dental devices such as braces. This device is meant to combine oral care procedures such as tooth brushing and dental flossing in one instance and will yield better dental hygiene and with better compliance.

In one example, there are many nozzles or cutout openings custom designed and personalized, each aiming at its area of interests.

Inside the device, a flow control system is designed to make sure the pressure delivered to each nozzle or cutout opening reaches the desired spray properties: aim, liquid pressure, velocity, spray pattern. Such flow control system may include one or more reservoirs and blockages. The flow control system can also incorporate various winding channels, often not intersecting with one another. Such flow control can be achieved by using design tools such as flow dynamic simulation engine, e.g. flow dynamics analysis, finite element analysis, finite difference analysis.

In another example, a water powered brush can be attached to the nozzles or cutout openings described. Furthermore, sensor or sensor gauge can be attached as well to control the water flow and pressure when needed. Further, a control, sometimes using software, can be used to adjust the sensor value to adjust the flow as needed.

In another example, the body may also include a motor, a pump, and a drive mechanism coupling the motor to the pump, with the pump controllably delivering fluids from the water base to the nozzles or cutout openings. An on/off control or switch may be utilized to activate and deactivate the motor.

In another example, the device may also include one or more drainpipes, which extract the excess fluid out of the mouth.

In another example, a software app maybe used to track the usage. Moreover, the software can adjust brush time, enhance area of focus or reduce the intensity of certain area, for example due to sensitive tooth or gum.

### BRIEF DESCRIPTION OF THE DRAWINGS

FIG. 1 illustrates a customized and personalized oral irrigation device, where the mouthpiece is custom made contoured with a user's dentition, and the inflow pipe, drain pipe and nozzles or cutout openings, in accordance with an embodiment of the present invention.

FIG. 2 illustrates a customized liquid flow control design, where the goal is to achieve each desired spray properties of each nozzle or cutout openings, where small reservoir and flow blockage are used, in accordance with an embodiment of the present invention.

FIG. 3 illustrates another customized liquid flow control design, where the goal to achieve each desired nozzle or cutout openings spray properties, where different flow paths are used, in accordance with an embodiment of the present invention.

FIG. 4 illustrates the design flowchart of a customized oral irrigation device, in accordance with an embodiment of the present invention.

FIG. 5 illustrates the design of using flow analysis system to analyze, sometimes iteratively, to achieve the desired spray properties, in accordance with an embodiment of the present invention.

FIG. 6 illustrates the cross section of the design of a customized oral irrigation device, where the device is offset from the crown part of teeth, leaving room for liquid to power spray to the crown, and in snug contact to the gum, in order to control outflow liquid and drain, in accordance with an embodiment of the present invention.

FIG. 7 illustrates another customized oral irrigation device, where the mouthpiece is custom made contoured with a user's dentition, and each dental arch is made as a separate unit. The diaphragm is made to have the inflow pipe, connectors to the separate mouthpiece, which provides inflow and drain for each arch mouthpiece, in accordance with an embodiment of the present invention.

FIG. 8 shows the occlusal view of the diaphragm, a horseshoe like shape adapt to upper and lower arch shapes.

FIG. 9 provides detailed steps on how the mouthpieces and the diaphragm are designed.

FIG. 10 illustrates such workflow with diaphragm.

FIG. 11 illustrates a supporting structure design which offset mouthpiece away from the teeth to give proper anchorage and wash space

FIG. 12 illustrates a thin shell design, where the device is made of closed volume between two thin plates, where such thin plates usually contoured with tooth surface, and have internal supporting structure.

FIG. 13 illustrates a method that one or more flexible material part connects upper and lower parts, such adjustment adapts to bite estimation error.

FIG. 14 illustrates another embodiment, mating feature.

FIG. 15 illustrates the enclosure for prewash device

FIG. 16A illustrates the cross section of a water spray channel inner wall

FIGS. 16B and 16C illustrate the cross section of a water spray channel inflow direction related to anterior (A) and posterior (P) teeth.

FIG. 17 illustrates the cross section of water spray channel inner wall where a movable part is placed.

FIG. 18 illustrates the workflow how such design is achieved.

### DETAILED DESCRIPTION OF THE INVENTION

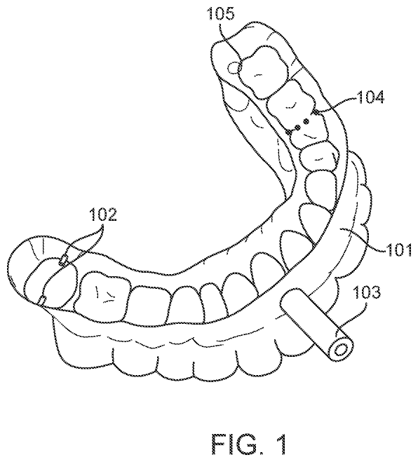

Disclosed herein are various embodiments of a custom-made oral irrigation device. Referring to FIG. 1, the device 101 is shaped like a mouth guard, but custom designed to offset from the user's crown to a distance, usually larger than, e.g., 0.1 mm but smaller than 100 mm Custom designed anchor posts 102 are designed to anchor the irrigation device to the teeth. An inflow pipe 103, often connected to an out of mouth pumping unit, is used to pump in irrigation liquid. The inflow pipe is connected to multiple nozzles or customized cutout openings 104 (only few are shown as examples), which are again custom designed to aim at desired areas. One or more drain holes 105 are designed, either to pump or drain excess liquid out of the device. Each nozzle or cutout openings is custom designed to reach required spay properties: flow pressure, flow speed and flow volume depending on the area of irrigation, tooth sensitivity, cleanness of teeth or gum.

In another embodiment, multiple units of inflow, nozzles or cutout openings and drain hole are designed, so teeth can be irrigated a section at a time. This design may be desirable for miniaturizing the irrigation pumping units, especially desired for portability or travel, or the need to have the pump powered by battery.

On the inner surface of the irrigation device, a camera or sensor maybe installed to sense the cleanness of the corresponding area, the proper control units can be installed to adjust the irrigation process based on the sensing data.

The inflow liquid can include, but not limited to, whitening, bleach, cleaning solution, anesthesia or water, which can be controlled from the outside with any desired inflow sequence.

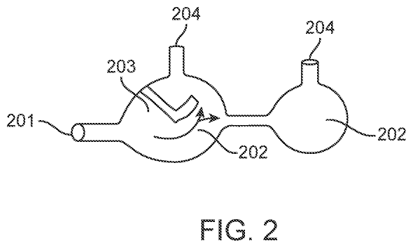

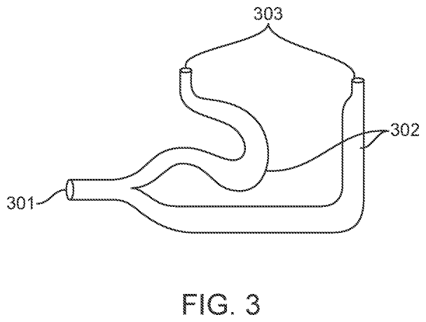

Once the liquid is pumped into the inflow pipe, it disperses through channels specially designed inside the irrigation device, and eventually come out to each individual nozzle or cutout openings. Each nozzle or cutout openings is custom designed to aim at areas of interest with desired flow control such as but not limited to velocity, pressure, volume, pulsing patterns. To better manage flow, different designs are implemented. FIG. 2 shows one of the implementations for flow control. Once inflow 201 comes in, special reservoirs 202 are designed to hold the liquid to volume and to better control fill speed. Sometimes, some blockage unit 203 is designed, combining reservoirs and blockage. FIG. 3 shows another implementation for flow control. Once inflow 301 comes in, special paths 302, e.g., often curved, are designed to guide the liquid to travel in certain patterns in order to reach the desired pressure, volume and velocity at the nozzles or cutout openings 303.

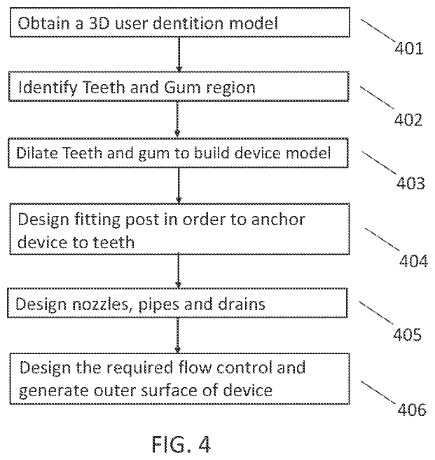

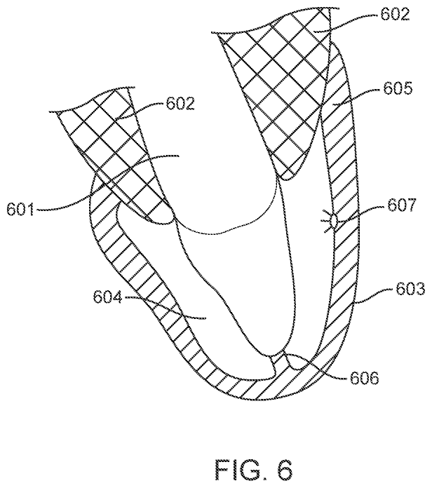

FIG. 4 describes more detailed steps on how the mouthpiece device is designed. First, 401, a digital representation of user dentition is acquired. Such acquisition can be done by taking a dental impression and using the scanner to scan it; or using an intraoral scanner like the Trios® scanner (3Shape A/S, Copenhagen, Denmark) to scan user teeth directly. Sometimes, just using an intraoral camera or a mobile phone camera can obtain a good dentition model due to high quality photos and better image registration tools of those devices. Then, 402, the teeth and gum are identified. Often an AI based tool like uDesign software, developed by uLab Systems Inc. (Redwood City, Calif.), can detect such features automatically. Then 403, the teeth part is dilated to leave room for nozzles or cutout openings to spray. Some sharp features are smoothed as well. A detailed process will be described in FIG. 6, which shows a cross section display. Various fitting posts are designed to anchor the mouthpiece to the teeth 404 firmly and keep most of the mouthpiece area to desired distances. The post may have sensors in place, which detect whether the mouthpiece is properly place to teeth, the nozzles or cutout openings, inflow pipe or pipes and drains layout is designed 405 including the desired spray properties: pressure, aim, velocity, etc. 406, the internal mouthpiece is deigned to achieve the desired nozzle or cutout opening behavior. And the outer surface is designed to encapsulate the pipes and reservoirs. Such design is outputted to a manufacturable process to produce the mouthpiece device; such manufacture process can be but not limited to a 3D printing process.

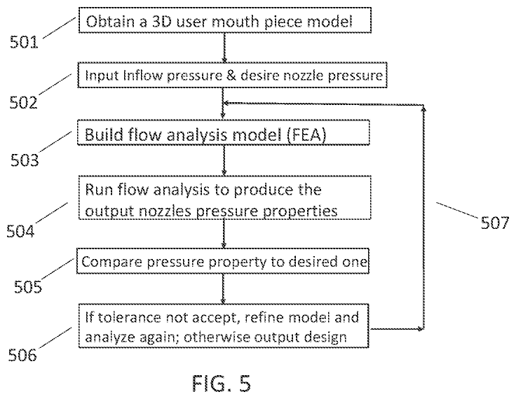

One of the desirable features is flow control and how-to custom design a mouthpiece which takes the inflow and distribute the liquid to various nozzles or cutout openings properly, with the right flow amount, velocity, pressure etc. FIG. 5 illustrates one of such design flowcharts. First 501, a 3D user mouthpiece model is inputted. Then 502 inflow pressure and outflow desired nozzle or cutout opening flow are inputted as well. Based on the inputs, and preliminary calculation, an initial design of pipes, reservoirs or blockage are designed and lay inside the mouthpiece model. The proper flow analysis tools adopted are based on the model 503. Such analysis tool can be but not limited to a finite element analysis model, where pipes, reservoirs, blocks are meshed to individual finite elements. These elements can be but not limited to tetrahedron or hexahedron elements; such mesh can be generated by gridding of the known pipes, reservoirs, blocks from known template. Running the flow analysis to generate the simulated nozzles or cutout openings flow properties 504, including pressure, velocity, spay range etc. Then 505, compare the above results with desired outcomes and check the tolerance, if the results are within the range of the desired outcome, we have achieved a preliminary design. Otherwise, based on the discrepancy, modify the design of pipes, reservoirs or blockage, go through the design process again, 507, until one of the designs converges to with the nozzle or cutout openings property tolerance 506. Sometimes, but rarely, due to special mouth conditions, the mouthpiece profile may need to be altered as well. The above process will be needed for each customized and individualized mouthpiece produced.

To manage the flow and drain better, it is preferable to enclose the space between inner surface and teeth, FIG. 6 provides a more detailed illustration of a cross-section profile with the mouthpiece and teeth where 601 is the teeth/crown part, 602 is the related gum, the mouthpiece device 603 has an offset or clearance 604 to the crown 601, and snug fit or contact to the gum 605. A clearance between the teeth and the device is achieved by placing various anchor posts 606 in the mouthpiece; such clearance enables the nozzle or cutout opening 607 to spray teeth effectively and excess liquid can be drained effectively. This is especially useful for children, seniors, and disabled, who may not be able to handle mouth liquid well and can swallow it accidently.

Inflow pipe usually comes in through the facial surface of incisor, a flow dynamic algorithm is developed, to enable liquid to dispatch through device distally as quickly as possible. In order to make the device easy to put on and comfortable to use, usually we maintain the thickness of buccal and occlusal surface as thin as possible. In order to allow maximum pass through, for anterior teeth, the thickness can be increased on the lingual side, and the height can be increased on the buccal side as well. Such optimization is usually achieved by assigned weight factors in regions to simulate the required device shape to reach the desire spay property.

In order to push items from interproximal area out, the nozzles or cutout openings are fanned out to graduate towards to occlusal surface when possible, so wash push towards occlusal surface. For the gum region, nozzles or cutout openings are fanned out from a low gum point sideways to both sides to gradually point up.

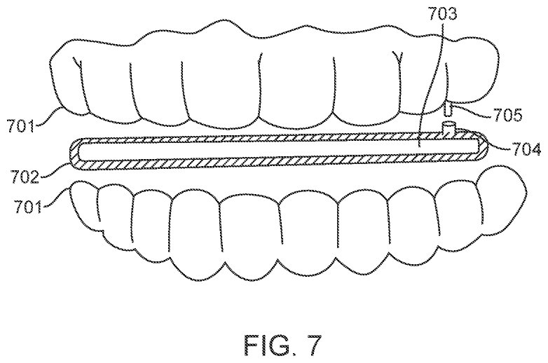

FIG. 7 illustrates another embodiment of a custom-made oral irrigation device, where the mouthpiece is custom made contoured with the user's dentition, and each dental arch 701 is made as a separate unit. A diaphragm 702 is made to sit in between the two mouthpieces, with the cross-section shown here, and connects to the inflow pipe, with the reservoir 703 holding liquid. It also has pipe connectors 704, maybe in a female feature to the receiving connectors 705 maybe in a male feature of each mouthpiece. A similar configuration can be used for draining management as well, which provides inflow and drain for each arch mouthpiece, in accordance with an embodiment of the present invention.

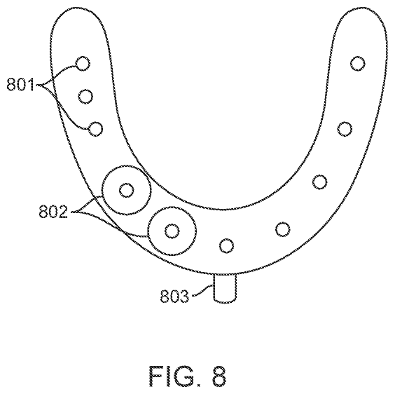

FIG. 8 shows the occlusal view of the diaphragm, a horseshoe like shape adapt to upper and lower arch shapes. Several connectors 801 to connect the flow to upper and lower arches. The connectors can connect to separate reservoir cells 802, and each cell connects to the main inflow pipe 803 or each other serially towards main inflow pipe 803. Outflow or drainpipes are managed in a similar fashion. Such management can give a better flow control because valves can be placed between cells to control each cell to reach desired pressure. Such design also allows the mouthpiece to be sections instead of individual cells, section by section, resulting in a simpler internal flow pipe, blockage, reservoir design.

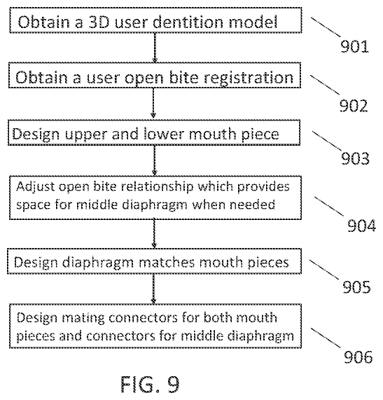

FIG. 9 provides detailed steps on how the mouthpieces and the diaphragm are designed. First, 901, a digital representation of user dentition is acquired, such acquisition can be done by taking a dental impression and using the scanner to scan it; or to use an intraoral scanner like Trios to scan user teeth directly. Sometimes, just use intraoral camera or a mobile phone camera can obtain a good dentition model due to the high-quality photos and better image registration tools in such devices. Then user's open bite relationship 902 is obtained, user can take open bite impression to register it to both arches, or open bite scan or image to register to both arches. Sometimes this can be calculated by putting both lower and upper arches to a best bite fitting position without bite impression or bite scan or bite image. The open bite relationship is different than typical bite relationship, it needs to articulate the teeth to an open bite position which creates space for both mouthpieces and have enough space for a middle diaphragm to be inserted in the middle. In order to have the right clearance, a special bite block or impression tray maybe needed to take open bite impressions or scans when the user has the needed open bite position. Then, follow the same steps described in FIG. 4 to design both mouthpieces, with consideration for the diaphragm to make sure the connectors are within the right range. If needed, adjust the bite relationship 904. With each mouthpiece in place, design the diaphragm to adapt to both mouthpieces 905. Design flow mating connectors between diaphragm to upper arch and diaphragm to the lower arch to manage the inflow from diaphragm to mouthpieces and outflow from mouthpieces to diaphragm 906. The diaphragm can be premade to several types to cover all dental arch shapes.

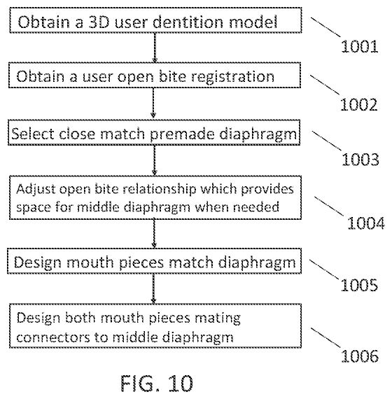

FIG. 10 illustrates such workflow: step 1001 is same as step 901, and step 1002 is same as step 902. One of premade diaphragm is selected by compare the best match to the arch forms of both upper and lower arches 1003. While middle diaphragm is place, adjust the bite relationship if needed to have enough space for both mouthpieces 1004. Both mouthpieces are designed to adapt to selected diaphragm 1005. Then the corresponding connectors to match the selected diaphragm are designed. The corresponding inner pipes and drains are designed as well.

Although this design may snap upper and lower pieces to the diaphragm before use, it has several advantages:
1. The diaphragm and mouthpieces can be fabricated in different materials for their uses. In one example, the diaphragm can be made using durable rubber like material which has the desired reservoirs, while the mouthpieces can be made using harder material e.g. ABS which provides designed spray properties.
2. The diaphragm and mouthpieces can be fabricated by different manufacturing methods, e.g. mouthpieces can be 3D printed to adapt the complex design of pipe, blockage and reservoir structures. But it is harder to place electronic elements in such a structure due to its complex shape and its needs for water resistance. However, if the diaphragm is made by other method, e.g. casting, electronic elements can be placed inside easily. In addition, when needed, the mechanical flow control elements can be placed in it easily as well. For example, the diaphragm can be divided into smaller cells and each cell can have its own outflow and drain, services a small section of the mouth, and have valves that can be switched on and off at different times, like sprinklers. This is important if low power pump unit is needed, e.g. in a traveler kit powered by a battery pack.
3. As described in FIG. 10, the diaphragm can be premade to several standard shapes based on common arch forms, then instead of custom making individual custom diaphragm, best match method can be used to find and select the best pre-fabricated diaphragm and alter mouthpieces design to the diaphragm. This may reduce the manufacturing cost.
4. As the diaphragm can be made with slightly soft material, it tolerates well to the open bite design error and provides some cushion in order to bite the device to teeth properly.
5. Cost of electronics and flow control elements is high, it is thus economical if they are placed in the diaphragm which lasts longer than the mouthpieces. Mouthpieces can be 3D printed to many sets to fit the same diaphragm. So overall cost will be lower in this design.
6. User mouth condition may change over time. When it does, only new design of mouthpieces will be necessary, and the new design may fit the current diaphragm in use instead of having to replace all three pieces.

The liquid pump is a standard pump, which has the connector to the inflow pipe. On the pump, a timer maybe installed to record usage of the device and such data can be transmitted wirelessly to a mobile device, which can also have software installed to analysis the data. Similarly, sensors or cameras can be mounted to mouthpieces as well to detect cleanness or effectiveness of irrigation, and such data can be transmitted to a mobile device which can adjust the flow control of the area accordingly. Of course, the user can adjust the flow control without sensor data, e.g. user can reduce an area flow due to sudden tooth pain.

Usually such a device is electrically powered by using an electric outlet, but it can also be powered by a battery, or to extreme, a manual crank.

Special accessories can be attached or snapped on to the nozzles or cutout openings, e.g. a tiny brush or a flexible toothpick.

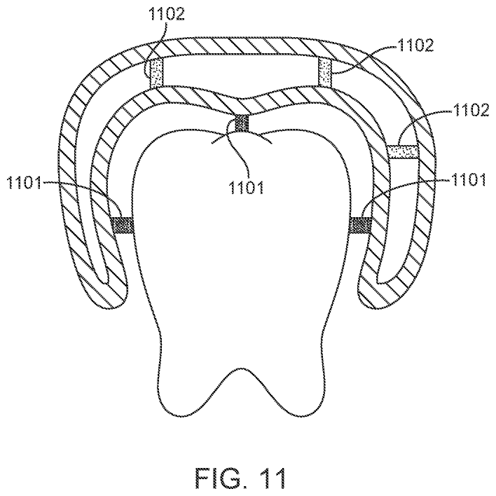

FIG. 11 illustrates supporting structure design, where small posts 1101 are designed to anchor the device on tooth also make sure clearing 1102 to the tooth surface so liquid can flow out quickly after wash. The post is usually between, e.g., 1 mm to 20 mm, in height.

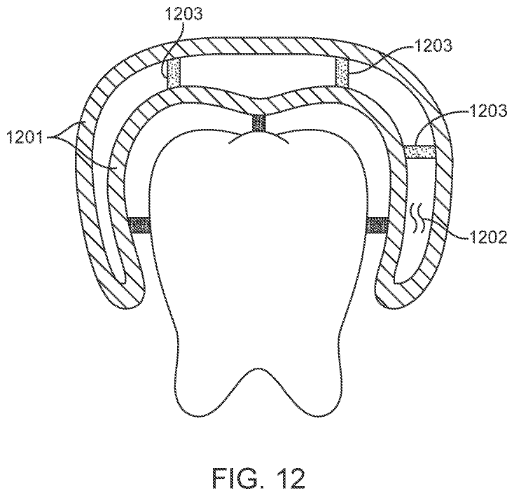

FIG. 12 illustrates a thin shell design, where the device is made of closed volume between two thin plates 1201, where such thin plates usually contoured with tooth surface. This allows quick water flow 1202 from side arch to side efficiently, supporting posts 1203 also placed inside shell to make sure device has strength to resist bite pressure.

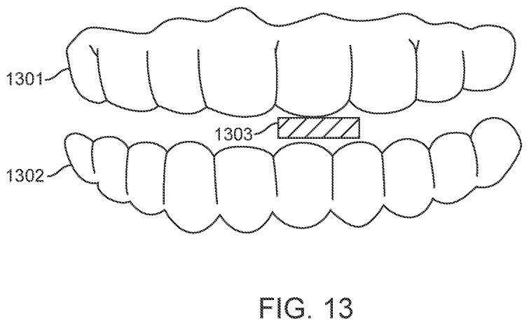

FIG. 13 illustrates a method that one or more flexible material part connects upper and lower parts, the flexible part can be insert to a post predesigned. This gives the flexibility to accommodate the bite variation or incorrect modeling. In such case, upper part 1301 and lower part 1302 are printed separately, but it is more convenient if two parts can be placed in one insert. The insert 1303 can adapt and connect the two, and 1303 can be adjust as well.

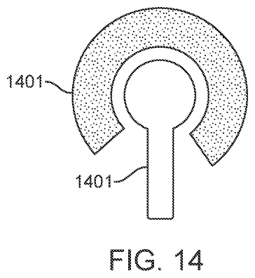

FIG. 14 illustrates another embodiment, mating features 1401, shown here in one example but not limited to ball and socket design, are designed and attached to upper and lower parts, hence paper and lower parts can be printed together, and connected with the mating features, the features also provide some flexibility for modeling tolerance.

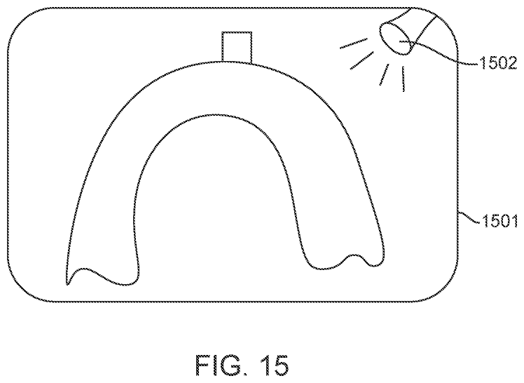

In order to keep the device sanitary, before use it is placed in mouth, a prewash cycle may be adopted, where the liquid may prewash the internal surface of the device prior to being placed on the teeth, the external surface like buccal surface can either be rinsed by placing device in an enclosure. FIG. 15 illustrates the enclosure 1501, it may have external wash head 1502 which washes the device properly.

Unlike prior art, which have predesign template nozzles layout through the teeth surface, the cutout is implemented through the inner shell wall, such cutout may be comprised of thin channels through the wall, may have different internal curvature, incisors have narrower and curvy inflow channels and posteriors have wider and straight channels; interproximal area and gum line region have wider and straight channels. Such channels are complex to make in traditional manufacturing method, but easier to use 3D printing technology.

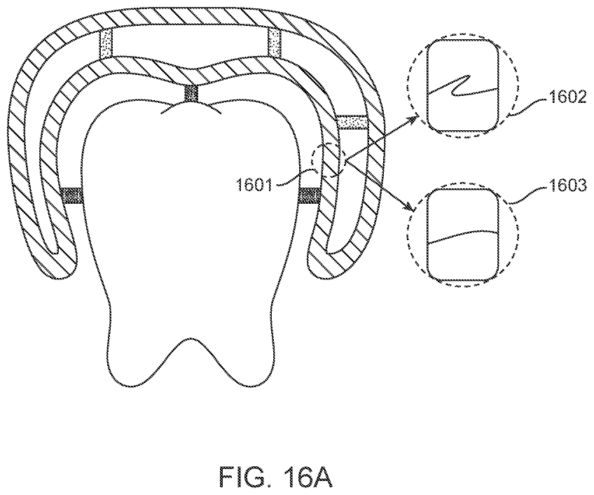

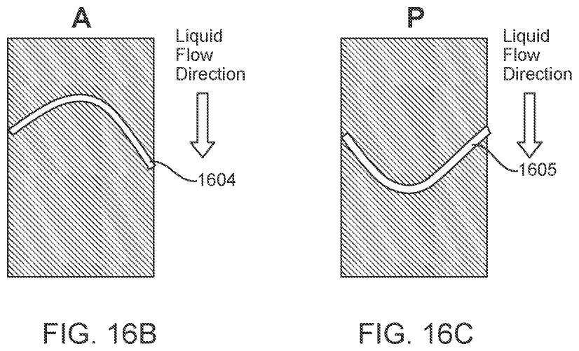

FIG. 16A illustrates the cross section of a water spray channel inner wall, it is not circular like sprinkles, but a continuous cut through slots along interproximal curve and gum line with connection structures to support, like a crack along a wall. The cut can have different thickness and curvature along the way. And for front teeth, the crack can be curvier 1602 and for back teeth, the crack can be relatively straighter 1603. The CFD may be used to determine a way to deliver efficiently liquid from anterior teeth (A) to posterior teeth (P) quickly with the constraint as shown in FIGS. 16B and 16C. Where 1604 at incisor area the channel or crack may be angled more against the flow direction to allow liquid to pass through quickly, to the posterior, and where the posterior is the opposite, the channel or crack may be angled toward the direction of the liquid flow to better receive the water flow 1605. Similarly, different height can be played as well.

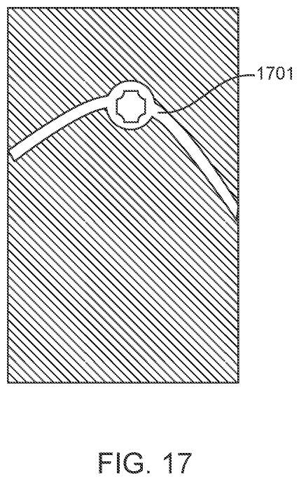

FIG. 17 illustrates the cross section of water spray channel inner wall where a movable part 1701 may be placed. With 3D printing technology, the movable part can be printed, which enables water to spray out of outlet with different pattern.

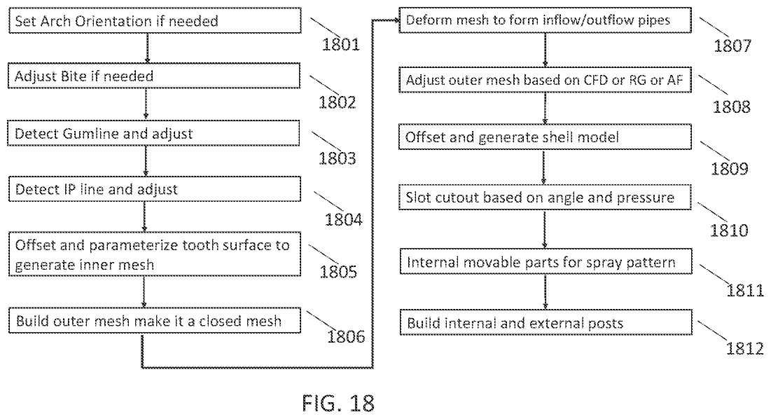

FIG. 18 illustrates the workflow, 1801 a digital model is received, the proper orientation is set, 1802 the proper bite relationship is adjusted, and an open bite relationship when the device is on is calculated. The gumline is detected and adjusted 1803, the interproximal line or region is detected and adjusted 1804 based on gumline and interproximal information, and proper offset value is provided, offset value can be different based on the tooth type and region of interests 1805, a single blanket inner mesh is generated 1806, this mesh can be topologically different or re-meshed 1807 to more suitable for manipulation and storage, this is the inner (closed to teeth) surface mesh of device outer body. The region can grow this mesh and generate the outer layer of the mesh, making it a watertight closed mesh, which defines the entity of out surface device body and insert or deform mesh structure to add inflow and optional outflow pipes. Again, the single mesh may be used to make future pipe and device deformation easier, and make sure the smooth transition between pipe and device.

Assuming the device maintain certain thickness, 1808 computational fluid dynamics or simpler region grow based on flow speed and volume, or advancing front based on flow flux front vectors are used to adjust our surface of device mesh to achieve the desired spay property in all regions, this can be an interactive process by keep changing the mesh and calculate the flow in regions, calculate the error tolerance, then re-adjust the mesh until all errors are within specified tolerance. The offset the outer surface inward to generate a shell solid model 1809, sharp edge is blended. The nozzles or cutout openings are implemented based on regions spay angle and pressure requirements 1810. Optionally, a movable part may be designed 1811 to modulate the spray pattern. External posts from device to teeth may be placed 1812 to anchor device to teeth, place internal posts between two walls to strengthen the device structure. Then complete mesh is output for fabrication, most likely 3D printed.

Due to device maybe used daily, sensors can be place inside to sense varies teeth conditions, e.g. teeth decay, particular enzyme etc.

Modification of the above-described assemblies and methods for carrying out the invention, combinations between different variations as practicable, and variations of aspects of the invention that are obvious to those of skill in the art are intended to be within the scope of the claims.

What is claimed is:

1. A computer-implemented method for producing appliances to irrigate teeth and gum, comprising:
providing an initial digital data set representing teeth and gum geometry and conditions;
specifying a configuration for a set of nozzles or cutout openings along one or more appliances in the digital data set, wherein the one or more appliances are configured to conform to the teeth and gum geometry from the digital data set, and wherein the set of nozzles or cutout openings are configured according to an optimization function to provide irrigation to the teeth and gums; and
producing the one or more appliances having the set of nozzles or cutout openings in accordance with the digital data sets.

2. A method of claim 1 wherein providing the initial digital data set representing teeth and gum geometry and conditions comprises scanning a three-dimensional model of teeth and gums of a subject.

3. A method of claim 1 wherein providing the initial digital data set representing teeth and gum geometry and conditions comprises photographing one or more images of teeth and gums of a subject.

4. A method of claim 1 wherein providing the initial digital data set representing teeth and gum geometry and condition comprises providing the initial digital data set via x-ray, ultrasound, infrared, CT scan, or MRI of teeth and gums of a subject.

5. The method of claim 1 wherein providing the initial digital data set representing teeth and gum geometry and conditions comprises inputting a digital representation of a closed and open bite relationship of the teeth.

6. The method of claim 1 wherein specifying a configuration for a set of nozzles or cutout openings comprises specifying spray direction, fluid volume, fluid pressure, or fluid velocity.

7. The method of claim 1 wherein the optimization function comprises finite element analysis, finite difference analysis, flow dynamics analysis, or experimental data optimization.

8. The method of claim 1 wherein the optimization function comprises a device volume minimization algorithm, a device cost minimization function, assignment of weight functions for arch regions, or assignment of a fan out function for arch regions.

9. The method of claim 1 wherein the optimization function comprises assignment of an inner wall cut out opening function for arch regions, wherein the cut out opening is angled counter to a direction of water flow.

10. The method of claim 9 wherein the cut out opening is further configured as a curved or arcuate shape at an inflow incisor area.

11. The method of claim 1 wherein the optimization function comprises placing a movable part inside inner wall cut out opening to modulate water spray.

12. The method of claim 1 wherein the optimization function comprises providing supporting posts along an inner surface of the one or more appliances to provide a clearing to the teeth.

13. The method of claim 1 wherein the optimization function comprises providing an enclosure wall snap fit for contacting against the gum to prevent excess liquid from entering a mouth of a subject.

14. The method of claim 1 wherein the optimization function comprises providing a drain for removing excess liquid.

15. The method of claim 1 wherein producing the one or more appliances comprises fabricating a mouthpiece.

16. The method of claim 15 wherein the mouthpiece includes a buffer part.

17. The method of claim 16 wherein the buffer part comprises a diaphragm and flow connectors for passing liquid.

18. The method of claim 1 wherein the one or more appliances comprise a mouthpiece having an inflow pipe for receiving liquid from a pump which is in fluid communication with the set of nozzles or cutout openings.

19. The method of claim 1 wherein producing the one or more appliances comprises a mouthpiece having at least one post structure to offset the mouthpiece from teeth.

20. The method of claim 1 wherein producing the one or more appliances comprises a mouthpiece having a thin plate design which follows a surface curvature of dentition.

21. The method of claim 1 wherein producing the one or more appliances comprises a mouthpiece having an upper piece and a lower piece which are configured to connect to one another.

22. The method of claim 1 further comprising prewashing the one or more appliances prior to use by a subject.

23. A computer program product, for producing appliances to irrigate teeth and gum, comprising instructions operable to cause a programmable processor to:
generate a digital representation of a mouthpiece;
specify a set of nozzles or cutout openings and their desired spray properties: aim, liquid pressure, velocity, spray pattern to irrigate the teeth and gum through nozzles or cutout openings arrangements, wherein at least some of the nozzles or cutout openings arrangements are represented by digital data sets, wherein specifying a design of spay properties comprises irrigation teeth and gum according to an optimization function; and
generate one or more appliances in accordance with the digital data sets wherein the appliances comprise a mouthpiece having inflow pipe to receiving liquid from a pump, and nozzles or cutout openings to spray out liquid through according desired spray property to irrigate the teeth and gum.

24. A system for treating teeth and gum, comprising:
a processor;
a display device coupled to the processor; and
a data storage device coupled to the processor, the data storage device storing instructions operable to cause the processor to:
generate a digital representation of a mouthpiece;
specify a set of nozzles or cutout openings and their desired spray properties: aim, liquid pressure, velocity, spray pattern to irrigate the teeth and gum through nozzles or cutout openings arrangements, wherein at least some of the nozzles or cutout openings arrangements are represented by digital data sets, wherein specifying a design of spay properties, comprises irrigation teeth and gum according to an optimization function; and;
generate one or more appliances in accordance with the digital data sets wherein the appliances comprise a mouthpiece having inflow pipe to receiving liquid from a pump, and nozzles or cutout openings to spray out liquid through according desired spray property to irrigate the teeth and gum.

25. The system of claim 24 wherein specify further comprises instructions to generate the digital data sets based on initial digital data sets until the digital data set representing the acceptable spray properties are achieved.

26. The system of claim 24 wherein the optimization function comprises irrigate teeth using flow analysis tools, simulated pipe management tool, genetic algorithm, cost minimization, or space minimization algorithm.
